(19) United States
(12) Patent Application Publication
(10) Pub. No.: US 2015/0172353 A1
(43) Pub. Date: Jun. 18, 2015

(54) METHOD AND APPARATUS FOR INTERACTING WITH A MEDIA PRESENTATION DESCRIPTION THAT DESCRIBES A SUMMARY MEDIA PRESENTATION AND AN ORIGINAL MEDIA PRESENTATION

(71) Applicants: Miska Hannuksela, Ruutana (FI); Chenghao Liu, Tampere (FI); NOKIA CORPORATION, Espoo (FI)

(72) Inventors: Miska Hannuksela, Ruutana (FI); Chenghao Liu, Tampere (FI)

(21) Appl. No.: 14/412,865

(22) PCT Filed: Jul. 11, 2012
(86) PCT No.: PCT/CN2012/078467

§ 371 Date: Jan. 5, 2015

(51) Int. Cl. H04L 29/06

(52) U.S. Cl. CPC H04L 65/608

(57) ABSTRACT

A method, apparatus and computer program product are provided in order to process and utilize a media presentation description that describes both a summary media presentation and an original media presentation. A method, apparatus and computer program product may permit one of more segments of the summary media presentation to be requested based upon the media presentation description. Additionally or alternatively, a method, apparatus and computer program product may permit switching between the summary media presentation and the original media presentation and/or switching between different views of the summary media presentation.

### TECHNOLOGICAL FIELD

An example embodiment to the present invention relates generally to the processing and utilization of a media presentation description and, more particularly, to the processing and interaction with a media presentation description that describes both a summary media presentation and an original media presentation.

### BACKGROUND

Hypertext Transfer Protocol (HTTP) is used for the delivery of real-time multimedia content over the Internet, such as in video streaming applications. Unlike the use of the Real-time Transport Protocol (RTP) over the User Datagram Protocol (UDP), HTTP is relatively easy to configure and is typically granted traversal of firewalls and network address translators (NATs), which makes it attractive for multimedia streaming applications. Various streaming techniques utilizing HTTP have been developed including adaptive streaming over HTTP based on the Moving Picture Experts Group-4 (MPEG-4) file format and commercial solutions, such as Microsoft Smooth Streaming, Apple Adaptive HTTP Live Streaming and Adobe Dynamic Streaming.

Adaptive HTTP streaming (AHS) was first standardized in Release 9 of the 3rd Generation Partnership Project (3GPP) packet-switched streaming (PSS) service. The MPEG dynamic adaptive streaming over HTTP (DASH) standard was then developed and published. 3GPP continued to develop adaptive HTTP streaming in communication with MPEG and published 3GP-DASH (Dynamic Adaptive Streaming over HTTP). As a result of their technical similarities, MPEG DASH and 3GP-DASH will be collectively referred to as DASH.

In DASH, the media presentation description (MPD) provides the necessary information for client devices to establish a dynamic adaptive streaming over HTTP. MPD contains information describing a media presentation, such as an HTTP-uniform resource locator (URL) of each segment of the media presentation which may be referenced by a client device in a GET segment request. In DASH, a hierarchical data model is used to structure a media presentation. A media presentation consists of a sequence of one or more periods with each period containing one or more adaptation sets, each adaptation set containing one or more representations, and each representation consisting of one or more segments. A representation is one of the alternative choices of the media content or a subset thereof with the alternative choices typically differing by the encoding choice, e.g. by bitrate, resolution, language, codec, etc. A segment contains a certain duration of media content, and metadata to decode and present the media content. A segment is identified by a uniform resource identifier (URI) and can be requested by a HTTP GET request.

The MPD may contain descriptors that make use of a common syntax. The elements of type DescriptorType permit the MPD, period, adaptation set and representation elements to be annotated and extended. The descriptor elements are commonly structured so as to contain a @schemeIdUri attribute that provides a URI to identify the scheme and an optional attribute @value attribute. The URI identifying the scheme may be a uniform resource name (URN) or a URL.

DASH applications that use one of these elements must define a scheme identifier in the form of a URI and must then define the value space for the element when that scheme identifier is used. The scheme identifier appears in the @schemeIdUri attribute. In an instance in which a simple set of enumerated values are required, a text string may be defined for each value and the string must be included in the @value attribute.

Two elements of type DescriptorType are equivalent, if the element name, the value of the @schemeIdUri and the value of the @value attribute are equivalent. If the @schemeIdUri is a URN, then equivalence shall refer to lexical equivalence. If the @schemeIdUri is a URL, then equivalence shall refer to equality on a character-for-character basis. If the @value attribute is not present, equivalence is determined by the equivalence for @schemeIdUri only. Attributes and element in extension namespaces are not used for determining equivalence.

The semantics of the attributes within an element of the type DescriptorType are provided in section [symbol] [symbol] of ISO/IEC 23009 as follows:

Semantics of Elements of Type DescriptorType

| Element or | | |
|---|---|---|
| Attribute | | |
| Name | Use | Description |
| Element of type | | specifies a descriptor. |
| DescriptorType | | |
| @schemeIdUri | M | specifies a URI to identify the scheme. The |
| | | semantics of this element are specific to the |
| | | scheme specified by this attribute. The |
| | | @schemeIdUri may be a URN or URL. |
| | | When a URL is used, it should also contain |
| | | a month-date in the form mmyyyy; the |
| | | assignment of the URL must have been |
| | | authorized by the owner of the domain name |
| | | in that URL on or very close to that date, to |
| | | avoid problems when domain names change |
| | | ownership. |
| @value | O | specifies the value for the descriptor |
| | | element. The value space and semantics |
| | | must be defined by the owners of the |
| | | scheme identified in the @schemeIdUri |
| | | attribute. |

Legend:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and preceded with an @.

Extensible Markup Language (XML) Syntax of Generic Descriptor

<!-- Descriptor -->

<xs:complexType name=“DescriptorType”>

<xs:sequence>

<xs:any namespace=“##other” processContents=“lax”

```
minOccurs=“0” maxOccurs=“unbounded”/>
  </xs:sequence>
  <xs:attribute name=“schemeIdUri” type=“xs:anyURI” use=“required”/>
  <xs:attribute name=“value” type=“xs:string”/>
```

```
  <xs:anyAttribute namespace=“##other”
  processContents=“lax”/>
```

</xs:complexType>

DASH service may be provided as an on-demand service or live service. As an on-demand service, the MPD is static and all segments of a media presentation are already available when a content provider publishes an MPD. In regards to a live service, however, the MPD may be static or dynamic depending on the method by which the segment URLs of an MPD are constructed and the segments are created continuously as the content is produced and published to DASH client devices by a content provider. Segment URLs may be constructed utilizing either a template-based construction method for the segment URLs or a segment list generation method. In the template-based construction method, a DASH client is able to construct segment URLs without updating an MPD before requesting a segment. However, in a segment list generation method, a DASH client device has to periodically download the updated MPDs to obtain the segment URLs. For a live service, a template-based construction method for segment URLs may be superior to the segment list generation method.

In regards to a template-based construction method, the derived SegmentInfo element may contain UrlTemplate element. The UrlTemplate@sourceURL attribute represents a string that contains one or more of the identifiers. The attributes shall contain the $Index$ identifier. A sub-string “$<Identifier>$” names a substitution placeholder matching a mapping key of “<Identifier>”. In the request URL, the substitution placeholder shall be replaced by the substitution parameter. Identifiers for URL templates are set forth by ISO/IEC 23009 as follows:

### Identifiers for URL Templates

| $<Identifier>$ | Substitution parameter | Format |
|---|---|---|
| $$ | Is an escape sequence, e.g., “$$” is | not applicable |
| | replaced with a single “$” | |
| $RepresentationID$ | This identifier is substituted | The format tag |
| | with the value of the attribute | shall not be |
| | Representation@id of the | present. |
| | containing Representation. | |
| $Number$ | This identifier is substituted with | The format tag |
| | the number of the corresponding | may be present. |
| | Segment. For an example DASH | If no format tag |
| | Client using this identifier to | is present, a |
| | construct the list Media Segment | default format |
| | URLs, refer to B.3. | tag with |
| | | width = 1 shall |
| | | be used. |
| $Bandwidth$ | This identifier is substituted with | The format tag |
| | the value of | may be present. |
| | Representation@bandwidth | If no format tag |
| | attribute value. | is present, a |
| | | default format |
| | | tag with |
| | | width = 1 shall |
| | | be used. |
| $Time$ | This identifier is substituted with | The format tag |
| | the value of the | may be present. |
| | SegmentTimeline@t attribute | If no format tag |
| | for the Segment being accessed. | is present, a |
| | Either $Number$ or $Time$ may | default format |
| | be used but not both at the | tag with |
| | same time. | width = 1 shall |
| | | be used. |

A media segment contains a certain duration of media content for playback at a normal speed with such duration being referred as the media segment duration or the segment duration. The content producer or service provider may select the segment duration according to the desired characteristics of the service. For example, a relatively short segment duration may be used in a live service to achieve a short end-to-end latency. The segment duration is typically a lower bound on the end-to-end latency perceived by a DASH client since a segment is a discrete unit for generating media data for DASH. In this regard, content is typically generated in such a manner that an entire segment of media content is made available for a content provider. Furthermore, many client devices use a segment as the unit for GET requests. Thus, in typical arrangements for live services, a segment can be requested by a DASH client device only when the whole duration of a media segment is available and has been encoded and encapsulated into a segment. For an on-demand service, different strategies of selecting segment duration may be used.

A segment may be further partitioned into subsegments, each of which contains complete access units. Subsegments are indexed by segment index, which contains information to map presentation time range and byte range for each subsegment and is used to make a HTTP GET request for a specific subsegment using a byte range HTTP request. If a relatively tong segment duration is used, subsegments may be used to keep the size of HTTP responses reasonable and flexible for bitrate adaptation.

DASH specifies different timelines including a media presentation timeline and segment availability times. The media presentation timeline indicates the presentation time of an access unit with media content which is mapped to the global common presentation timeline. The media presentation timeline enables DASH to seamlessly synchronize different media components which are encoded with different coding techniques and share a common timeline. A segment availability time indicates a wall-clock time and is used to signal clients the availability time of segments which are identified by HTTP URLs. A DASH client device is able to identify an availability time of a segment by comparing the wall-clock time to the segment availability time assigned to the respective segment. The segment availability time plays a key role in live delivery of media segments, referred to as live service. For live service, the segment availability time is different from segment to segment and a certain segment's availability time depends on the position of the segment in the media presentation timeline. For an on-demand service, the segment availability time is typically the same for all segments.

DASH supports rate adaptation by dynamically requesting media segments from different representations within an adaptation set to match varying network bandwidths. When a DASH client devices switches up/down a representation, coding dependencies within the representation have to be taken into account. A representation switch may only happen at a random access point (RAP) as typically used in video coding techniques such as h.264/AVC. In DASH, Stream Access Point (SAP) is introduced to provide a codec-independent solution for accessing a representation and switching between representations. In DASH, a SAP is specified as a position in a representation that enables playback of a media stream to be started using only the information contained in representation data starting from that position onwards, preceded by initializing data in the initialization segment, if any). Hence, representation switching can be performed in SAP.

A content provider may create segments and subsegments of multiple representations in a way that makes switching simpler. In a simple case, each segment and subsegment starts with a SAP and the boundaries of the segment and subsegment are aligned across the representation of an adaptation set. In such a case, a DASH client device is able to switch representations without error drift by requesting segments or subsegments from an original representation to a new representation. In DASH, restrictions to construct a segment and subsegment are specified in an MPD and the segment index in order to facilitate a DASH client device to switch representations without introducing an error drift. One of the usages of a profile specified in DASH is to provide different levels of restrictions to construct a segment and subsegment.

A user of a client device may want to view parts of media period in terms of presentation time. For example, the user may want to view highlights and/or a summary of a media clip to decide whether or not view the whole media clip. Moreover, a user may want to switch between the highlights and/or summary and the original presentation. For example, if the user watches a highlight covering the goals of a soccer game, but wishes to see the action of the game that happened before a particular goal, the user should switch from the highlights and/or summary to the original presentation. In conventional streaming, the media clip is encoded and formatted as a whole data set with the highlight and/or summary of media clip being made separately from the whole media clip such that it is time-consuming and inefficient to switch between the original presentation and the highlights and/or summary. Moreover, in DASH, no technique is provided for identifying the highlights and/or summary segments so that switching between the original presentation and the highlights and/or summary presentation is similarly time-consuming and inefficient.

### BRIEF SUMMARY

A method, apparatus and computer program product are provided in accordance with an example embodiment of the present invention in order to process and utilize a media presentation description that describes both a summary media presentation and an original media presentation. Thus, a method, apparatus and computer program product of an example embodiment of the present invention permit one of more segments of the summary media presentation to be requested based upon the media presentation description. Additionally or alternatively, a method, apparatus and computer program product of an example embodiment of the present invention permit switching between the summary media presentation and the original media presentation and/or switching between different views of the summary media presentation. As such, a user may more readily and efficiently interact with an original media presentation and a related summary media presentation.

In one embodiment, a method is provided that includes parsing a media presentation description that describes a summary media presentation and an original media presentation. The method of this embodiment also processes a portion of the media presentation description with a processor to determine addresses of respective segments of the summary media presentation. Further, the method of this embodiment requests one or more segments of the summary media presentation based on the addresses of the respective segments.

In another embodiment, an apparatus is provided that includes at least one processor and at least one memory including computer program code with the memory and the computer program code configured to, with the at least one processor, cause the apparatus to parse a media presentation description that describes a summary media presentation and an original media presentation. The memory and the computer program code are also configured to, with the at least one processor, cause the apparatus of this embodiment to process a portion of the media presentation description to determine addresses of respective segments of the summary media presentation and to request one or more segments of the summary media presentation based on the addresses of the respective segments.

In a further embodiment, a computer program product is provided that includes a non-transitory computer readable medium having computer-executable program instructions stored thereon with the computer-executable program instructions including program instructions configured to parse a media presentation description that describes a summary media presentation and an original media presentation. The computer-executable program instructions of one embodiment also include program instructions configured to process a portion of the media presentation description to determine addresses of respective segments of the summary media presentation and program instructions configured to request one or more segments of the summary media presentation based on the addresses of the respective segments.

In yet another embodiment, an apparatus is provided that includes means for parsing a media presentation description that describes a summary media presentation and an original media presentation. The apparatus of this embodiment also includes means for processing a portion of the media presentation description with a processor to determine addresses of respective segments of the summary media presentation. Further, the apparatus of this embodiment includes means for requesting one or more segments of the summary media presentation based on the addresses of the respective segments.

In one embodiment, a method is provided that includes parsing, with a processor, a media presentation description that describes a summary media presentation and an original media presentation. The method of this embodiment also includes causing one of the summary media presentation or the original media presentation to be presented. Further, the method of this embodiment includes switching to another one of the summary media presentation or the original media presentation while the one of the summary media presentation or the original media presentation is being presented such that the another one of the summary media presentation or the original media presentation is caused to be presented.

In another embodiment, an apparatus is provided that includes at least one processor and at least one memory including computer program code with the memory and the computer program code configured to, with the at least one processor, cause the apparatus to parse a media presentation description that describes a summary media presentation and an original media presentation and to cause one of the summary media presentation or the original media presentation to be presented. The memory and the computer program code are also configured to, with the at least one processor, cause the apparatus of this embodiment to switch to another one of the summary media presentation or the original media presentation while the one of the summary media presentation or the original media presentation is being presented such that the another one of the summary media presentation or the original media presentation is caused to be presented.

In a further embodiment, a computer program product is provided that includes a non-transitory computer readable medium having computer-executable program instructions stored thereon with the computer-executable program instructions including program instructions configured to parse a media presentation description that describes a summary media presentation and an original media presentation and program instructions configured to cause one of the summary media presentation or the original media presentation to be presented. The computer-executable program instructions of this embodiment also include program instructions configured to switch to another one of the summary media presentation or the original media presentation while the one of the summary media presentation or the original media presentation is being presented such that the another one of the summary media presentation or the original media presentation is caused to be presented.

In yet another embodiment, an apparatus is provided that includes means for parsing a media presentation description that describes a summary media presentation and an original media presentation. The apparatus of this embodiment also includes means for causing one of the summary media presentation or the original media presentation to be presented. Further, the apparatus of this embodiment includes means for switching to another one of the summary media presentation or the original media presentation while the one of the summary media presentation or the original media presentation is being presented such that the another one of the summary media presentation or the original media presentation is caused to be presented.

In one embodiment, a method is provided that includes parsing, with a processor, a media presentation description that describes a summary media presentation and an original media presentation. The method of this embodiment also identifies that the summary media presentation includes a plurality of views and causes a first of the plurality of views of the summary media presentation to be presented. Additionally, the method of this embodiment switches to a second of the plurality of views of the summary media presentation while the first view is being presented such that the second view is then caused to be presented.

In another embodiment, an apparatus is provided that includes at least one processor and at least one memory including computer program code with the memory and the computer program code configured to, with the at least one processor, cause the apparatus to parse a media presentation description that describes a summary media presentation and an original media presentation. The memory and the computer program code are also configured to, with the at least one processor, cause the apparatus of this embodiment to identify that the summary media presentation includes a plurality of views and to cause a first of the plurality of views of the summary media presentation to be presented. Additionally, the memory and the computer program code are configured to, with the at least one processor, cause the apparatus of this embodiment to switch to a second of the plurality of views of the summary media presentation while the first view is being presented such that the second view is then caused to be presented.

In a further embodiment, a computer program product is provided that includes a non-transitory computer readable medium having computer-executable program instructions stored thereon with the computer-executable program instructions including program instructions configured to parse a media presentation description that describes a summary media presentation and an original media presentation. The computer-executable program instructions of this embodiment also include program instructions configured to identify that the summary media presentation includes a plurality of views and program instructions configured to cause a first of the plurality of views of the summary media presentation to be presented. Additionally, the computer-executable program instructions of this embodiment include program instructions configured to switch to a second of the plurality of views of the summary media presentation while the first view is being presented such that the second view is then caused to be presented.

In yet another embodiment, an apparatus is provided that includes means for parsing a media presentation description that describes a summary media presentation and an original media presentation. The apparatus of this embodiment also includes means for identifying that the summary media presentation includes a plurality of views and means for causing a first of the plurality of views of the summary media presentation to be presented. Additionally, the apparatus of this embodiment includes means for switching to a second of the plurality of views of the summary media presentation while the first view is being presented such that the second view is then caused to be presented.

In one embodiment, a method is provided that includes creating a media presentation description for an original media presentation. The method of this embodiment also adds, with a processor, information regarding a summary media presentation to the media presentation description. The information may include addresses of respective segments of the summary media presentation. The method of this embodiment may additionally cause the media presentation description to be provided.

In another embodiment, an apparatus is provided that includes at least one processor and at least one memory including computer program code with the memory and the computer program code configured to, with the at least one processor, cause the apparatus to create a media presentation description for an original media presentation and to adds information regarding a summary media presentation to the media presentation description. The information may include addresses of respective segments of the summary media presentation. The memory and the computer program code are also configured to, with the at least one processor, cause the apparatus of this embodiment to cause the media presentation description to be provided.

In a further embodiment, a computer program product is provided that includes a non-transitory computer readable medium having computer-executable program instructions stored thereon with the computer-executable program instructions including program instructions configured to create a media presentation description for an original media presentation an program instructions configured to add information regarding a summary media presentation to the media presentation description. The information may include addresses of respective segments of the summary media presentation. The computer-executable program instructions of this embodiment also include program instructions configured to cause the media presentation description to be provided.

In yet another embodiment, an apparatus is provided that includes means for creating a media presentation description for an original media presentation and means for adding information regarding a summary media presentation to the media presentation description. The information may include addresses of respective segments of the summary media presentation. The apparatus of this embodiment may additionally include means for causing the media presentation description to be provided.

### BRIEF DESCRIPTION OF THE DRAWINGS

Having thus described some embodiments of the present invention in general terms, reference will now be made to the accompanying drawings, which are not necessarily drawn to scale, and wherein:

FIG. 1 is a block diagram of a system that may be specifically configured in accordance with an example embodiment to the present invention;

FIG. 2 is a block diagram of an apparatus that may be embodied by a content provider or a client device and that may be specifically configured in accordance with an example embodiment to the present invention;

FIG. 3 is a flow chart of the operations performed by an apparatus embodied by a client device in accordance with an example embodiment of the present invention;

FIG. 4 is a flow chart of the operations performed by an apparatus embodied by a client device in accordance with an another example embodiment of the present invention;

FIG. 5 is a flow chart of the operations performed by an apparatus embodied by a client device in accordance with a further example embodiment of the present invention; and

FIG. 6 is a flow chart illustrating the operations performed by an apparatus embodied by a content provider in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product of an example embodiment relate generally to the streaming of content such as media streaming, e.g., multimedia streaming. For example, the method, apparatus and computer program product of an example embodiment may support the delivery of real-time multimedia content over the interne, such as for video streaming applications, in accordance with HTTP and, more particularly, DASH. In this regard, DASH is utilized to reference MPEG DASH, 3GP DASH, and other DASH techniques.

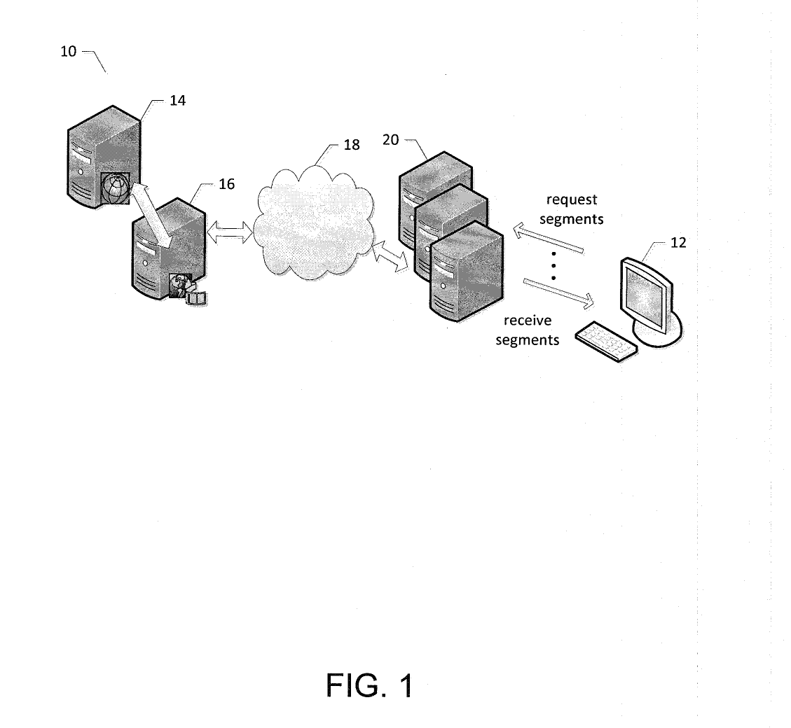

Although a method, apparatus computer program product of an example embodiment of the present invention may facilitate media streaming from a content provider to one or more client devices in a variety of different types of systems, FIG. 1 illustrates one example of a system in which media may be streamed from a content provider 10 to one or more client devices 12 in accordance with example embodiments of the present invention. As shown in FIG. 1, the content provider may include one or more servers or other computing devices that are configured to prepare and to provide the content, such as media and, more particularly, multimedia content. In the illustrated embodiment, the content provider includes one or more servers 14 configured to prepare the content and one or more other servers 16 configured to receive the prepared content and to provide the prepared content, such as by streaming over a network 18, such as the internet or any of wide variety of wireless and/or wireline networks, to one or more client devices.

In this regard, a variety of client devices 12 may be specifically configured in accordance with an example embodiment of the present invention in order to receive, process and present the content, such as the media and, more particularly, the multimedia content from the content provider 10. For example, a client device may be embodied as a mobile telephone, a personal digital assistant (PDA), a laptop computer, a tablet computer, a navigation system, a music player, a game player, computer workstation or any of numerous other computation devices, content generation devices, content consumption devices or combinations thereof. While the client devices may directly receive the streamed content via the network 18, such as the internet, from the content provider, the system of one embodiment includes one or more caching proxies 20, such as one or more servers, to receive and at least temporarily store the streamed content with the client devices thereafter requesting one or more segments of the streamed content from the caching proxies and, in turn, receiving the one or more segments that were requested.

In conjunction with DASH and other streaming techniques, a content provider 10 not only provides the original media presentation, but also a media presentation description that describes the original media presentation. In accordance with an example embodiment of present invention, a content provider also provides a summary media presentation that may provide a summary of the original media presentation or different portions of the original media presentation. In one embodiment, for example, the summary of the original media presentation or at least portions thereof includes highlights from the original media presentation or at least portions thereof. For example, in an instance in which the original media presentation is a video of a soccer match, the summary media presentation may include highlights from the soccer match including goals scored, particularly good saves by the goalie or the like.

In one embodiment, separate segments are not created to provide the summary media presentation. Instead, at least some of the segments of the original media presentation, which include highlights content, are identified and used as the segments of the summary media presentation. Hence, a content provider 10 of this embodiment need not separately create multiple segments for the summary media presentation and for original media presentation, thereby avoiding the workload otherwise required to create segments for the summary media presentation in addition to the segments for the original media presentation. The URLs of the segments the summary media presentation and URLs of the corresponding segments of the original media presentation are identical in this instance since the segments of the summary media presentation and the segments of the original media presentation are identical. Consequently, storage resources, such as at the content provider, within the network delivery chain, e.g. HTTP-caches, and client devices 12, may be conserved by only having to save the segments of the original media presentation as opposed to also having to save separate segments of the summary media presentation.

The media presentation description includes information, such as metadata, describing the summary media presentation and the original media presentation. Among other types of information, the media presentation description may include the addresses, such as the URLs, of the respective segments of the summary media presentation and the original media presentation. Thus, a uniform media presentation description is provided that includes metadata describing both the summary media presentation and the original media presentation. By providing a uniform media presentation description, a content provider 10 need not separately create multiple media presentation descriptions for the summary media presentation and the original media presentation, thereby avoiding the workload otherwise required to create multiple media presentation descriptions. Consequently, storage resources may be conserved by saving the uniform media presentation description as opposed to multiple media presentation descriptions.

Although the segments of the summary media presentation may be identified within the media presentation description in various manners, a descriptor and a corresponding scheme may be defined for the media presentation description to carry the metadata related to the segments of the summary media presentation so as to allow the segments to be located. The descriptor and the corresponding scheme may be located on the level of the adaptation sets and/or the representations. In one embodiment, an @schemeUri attribute may be utilized to identified the corresponding scheme that is employed. In this regard, one embodiment of Highlights@schemeIdUri in MPEG namespace may be specified as urn:mpeg:dash:highlights:2012 or, alternatively, specified as urn:mpeg:dash:summary:2012. Additionally or alternatively, another embodiment of Summary@schemeIdUri in 3GPP namespace may be specified as urn:3gpp:dash:highlights:2012 or, alternatively, specified as urn:3gpp:dash:summary:2012

In one embodiment of the corresponding highlights and/or summary scheme, @value shall be present to specify a set of enumerated segment start times or segment numbers of the segments of the summary media presentation. In case @value is used to specify the segment start time, the @value is expressed in media presentation time.

In the corresponding highlights and/or summary scheme, the URLs of the segments of the summary media presentation may be provided. In one embodiment, a segment template and segment number/segment time may be used to specify URLs of one or multiple segments, which may or may not be continuous in media presentation time. The segment template shall be derived from the corresponding level of segment template element, which is specified for the original media presentation, in the adaptation set and representation.

In one embodiment in which a highlights element (also synonymously referenced as a summary element) is present in an adaptation set, the values of the attribute Highlights@value may substitute either $Number$ or $Time$ in the segment template and the value of the attribute Representation@id or Representation@bandwidth of all representations of the adaptation set may substitute either $RepresentationID$ or $Bandwidth$ of the segment template.

In an embodiment in which a highlights elements is present in a Representation, the values of the attribute Highlights@value may substitute either $Number$ or $Time$ in the segment template, and the value of the attribute Representation@id or Representation@bandwidth of the Representation may substitute either $RepresentationID$ or $Bandwidth$ of the segment template.

In yet another embodiment in which the highlights elements are present in one or multiple levels, the highlights element shall inherit attributes from the highlights element on a higher level. In the foregoing example embodiment, the adaptation set is a higher level relative to the representations and the period is a higher level relative to the adaptation sets. If the same attribute of the highlights element is present on multiple levels, then the attribute of the highlights element on the lower level shall take precedence over the one the higher level.

By way of example, Table 1 shows the semantic of an embodiment of a highlights element.

TABLE 1
Semantics of a highlights element

| Element or | | |
|---|---|---|
| Attribute | | |
| Name | Use | Description |
| Highlights | | specifies a highlights descriptor. |
| @schemeIdUri | M | specifies a URN to identify the highlights scheme. The |
| | | semantics of this element are specific to the scheme |
| | | specified by this attribute. |
| @value | M | specifies a set of enumerated segment start time or |
| | | segment number of the highlights segments. The |
| | | segment start time or segment number of the highlights |
| | | segments represents ordered list in ascending order. In |
| | | case @value is used to specify the segment start time, |
| | | the @value is expressed in media presentation time. |
| @highlightsid | O | specifies a certain highlights id for a highlights |
| | | presentation. |
| | | @highlightsid may be used to associate multiple |
| | | highlights elements present in different representations. |
| | | @highlightsid may be used to associate multiple |
| | | highlights elements present in different adaptation sets. |
| | | @highlightsid may be used to associate multiple |
| | | highlights elements present in different periods. |
| | | @highlightsid specifies that the @values of highlights |
| | | elements, assigned with an identical @highlightsid, are |
| | | identical in an adaptation set. Hence, seamless |
| | | switching between different highlights/presentation can |
| | | be obtained. @highlightsid may be used to specify the |
| | | highlights completeness level in terms of highlighting |
| | | (or summarizing) the original media presentation. The |
| | | @value of a highlights element having larger |
| | | @highlightsid should enumerate more highlights |
| | | segments number/start times compared to the @value |
| | | of a highlights element having a smaller @highlightsid. |
| | | @highlightsid may be used to associate multiple types |
| | | and/or views of highlights presentations, which may be |
| | | presented in a synchronous manner or asynchronous |
| | | manner, with a certain highlights. |
| @highlightsMediaPresentation | O | specifies the duration of the entire highlights media |
| Duration | | presentation if @type = “static”. Otherwise if |
| | | @type = “dynamic”, then specifies the duration of the |
| | | available highlights media presentation. The attribute |
| | | shall be present at least in one highlights element in a |
| | | MPD. |
| @highlightsstart | O | if present, specifies start time of the highlights |
| | | presentation. |
| @highlightsduration | O | if present, specifies duration of the highlights |
| | | presentation. |

Legend:
For attributes: M = Mandatory, O = Optional
For elements: <minOccurs> . . . <maxOccurs> (N = unbounded)
Elements are bold; attributes are non-bold and preceded with an @.

Continuing with the foregoing example, an embodiment of the extensible markup language (XML) syntax of a highlights descriptor is shown as follows.

<!—Summary Descriptor -->

<xs:complexType name=“Highlights”>

<xs:sequence>

<xs:any namespace=“##other” processContents=“lax”

```
minOccurs=“0” maxOccurs=“unbounded”/>
  </xs:sequence>
  <xs:attribute name=“schemeIdUri” type=“xs:
urn:mpeg:dash:highlights:2012” use=“required”/>
  <xs:attribute name=“value” type=“xs:string”/>
```

```
  <xs:attribute name=“@highlightsid” type=“xs:string”/>
<xs:attribute name=“@highlightsMediaPresentationDuration”
type=“xs:duration”/><xs:attribute name=“@highlightsstart”
type=“xs:duration”/>
<xs:attribute name=“@ highlightsduration” type=“xs:
duration”/>
  <xs:anyAttribute namespace=“##other”
  processContents=“lax”/>
```

</xs:complexType>

By way of another example, Table 2 shows the semantics of another embodiment of a highlights element. Table 2 differs from Table 1 in various manners including, for example, the highlights segments and highlights id being specified in @highlightssegmentids and @value in Table 2 and in @value in Table 1.

TABLE 2
Semantics of a highlights element

| Element or | | |
|---|---|---|
| Attribute | | |
| Name | Use | Description |
| Highlights | | specifies a highlights descriptor. |
| @schemeIdUri | M | specifies a URN to identify the highlights scheme. The |
| | | semantics of this element are specific to the scheme |
| | | specified by this attribute. |
| @value | M | specifies a certain highlights id for a highlights |
| | | presentation. |
| | | The highlights id may be used to associate multiple |
| | | highlights elements present in different representations. |
| | | The highlights id may be used to associate multiple |
| | | highlights elements present in different adaptation sets. |
| | | The highlights id may be used to associate multiple |
| | | highlights elements present in different periods. |
| @highlightssegmentids | M | specifies a set of enumerated segment start time or |
| | | segment number of the highlights segments. The |
| | | segment start time or segment number of the highlights |
| | | segments represents ordered list in ascending order. In |
| | | case @highlightssegmentids is used to specify the |
| | | segment start time, the @highlightssegmentids is |
| | | expressed in media presentation time. |
| @highlightsMediaPresentation | O | specifies the duration of the entire highlights media |
| Duration | | presentation if @type = “static”. Otherwise if |
| | | @type = “dynamic”, then specifies the duration of the |
| | | available highlights media presentation. |
| @highlightsstart | O | if present, specifies start time of the highlights |
| | | presentation. |
| | | The highlightsstart is used as an anchor to determine the |
| | | MPD start time of each Media Segment as well as to |
| | | determine the presentation time of each each access unit |
| | | in the Media Presentation timeline. |
| @highlightsduration | O | if present, specifies duration of the highlights |
| | | presentation, which may be used to specify the start |
| | | time of the subsequent highlights presentation. |

Legend:
For attributes: M = Mandatory, O = Optional
For elements: <minOccurs> . . . <maxOccurs> (N = unbounded)
Elements are bold; attributes are non-bold and preceded with an @.

Continuing with the foregoing example, another embodiment of the XML syntax of a highlights descriptor is shown as follows.

<!—Summary Descriptor -->

<xs:complexType name=“Highlights”>

<xs:sequence>

<xs:any namespace=“##other” processContents=“lax”

```
minOccurs=“0” maxOccurs=“unbounded”/>
  </xs:sequence>
  <xs:attribute name=“schemeIdUri” type=“xs:
urn:mpeg:dash:highlights:2012” use=“required”/>
  <xs:attribute name=“value” type=“xs:string”/>
```

```
  <xs:attribute name=“@highlightssegmentids”
  type=“xs:string”/>
<xs:attribute name=“@highlightsMediaPresentationDuration”
type=“xs:duration”/>
<xs:attribute name=“@highlightsstart” type=“xs: duration”/>
<xs:attribute name=“@ highlightsduration” type=“xs:
duration”/>
  <xs:anyAttribute namespace=“##other”
  processContents=“lax”/>
```

</xs:complexType>

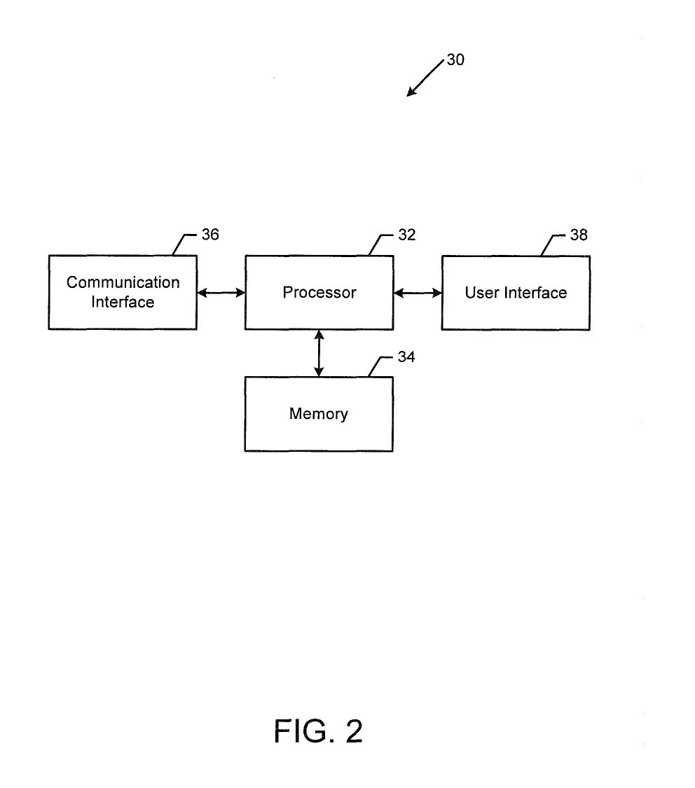

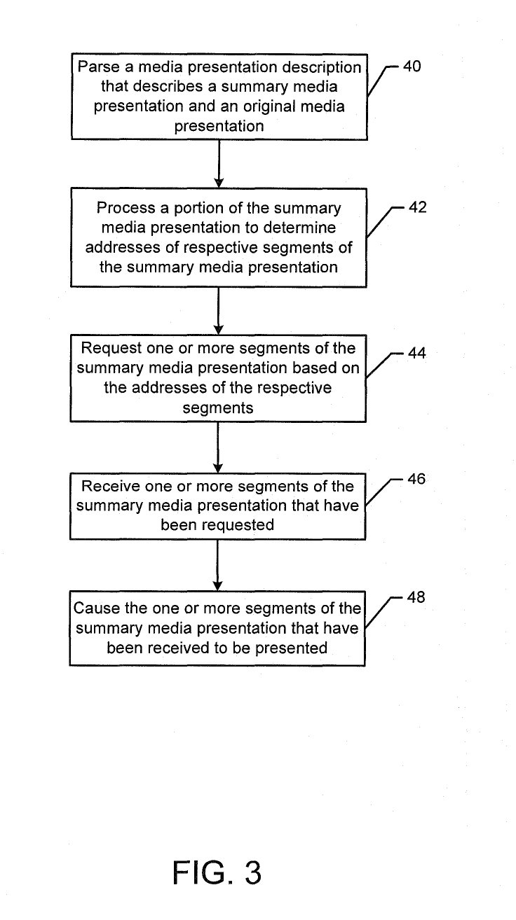

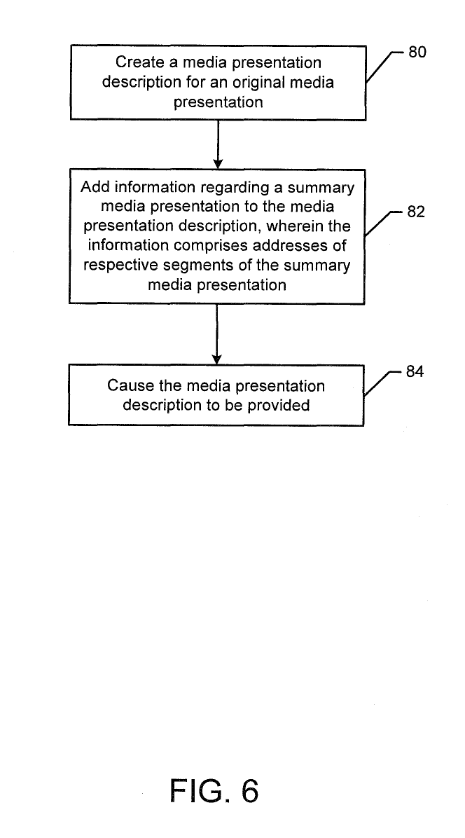

The content provider 10 and the client device 12 may each embody or otherwise be associated with an apparatus 30 that is generally depicted in FIG. 2 and that may be configured to perform various operations in accordance with an example embodiment of the present invention as described below, such as in conjunction with FIGS. 3-5 from the perspective of the client device and FIG. 6 from the perspective of the content provider. However, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 30 may include or otherwise be in communication with processing circuitry that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include a processor 32 and memory 34 that may be in communication with or otherwise control a communication interface 36 and a user interface 38. As such, the processing circuitry may be embodied as a circuit chip (e.g., an integrated circuit chip) configured (e.g., with hardware, software or a combination of hardware and software) to perform operations described herein.

The user interface 38 may be in communication with the processing circuitry to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the station by receiving user input and providing output.

The communication interface 36 may include one or more interface mechanisms for enabling communication with other computing devices and/or networks. In some cases, the communication interface may be any means such as a device or circuitry embodied in either hardware, or a combination of hardware and software that is configured to receive and/or transmit data from/to a network 18 and/or any other computing device in communication with the processing circuitry, such as between the content provider 10 and the client device 12 via the network in the embodiment of FIG. 1, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. Additionally or alternatively, the communication interface may be configured to transmit and receive information or other signals via a proximity-based communication protocol, such as via Wi-Fi, NFC, BlueTooth™, WiMAX or the like, so as to support communications with other proximately-located devices.

In an example embodiment, the memory 34 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 32. Additionally or alternatively, the memory could be configured to store instructions for execution by the processor. As described below, the memory may include one or more databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 32 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 24 or otherwise accessible to the processor. As such, whether configured by hardware or by a combination of hardware and software, the processor may represent an entity (e.g., physically embodied in circuitry in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In one embodiment, a client device 12 may receive a media presentation description that describes both a summary media presentation and an original media presentation. In this regard, the client device may request the media presentation description from the content provider 10 or the media presentation description may be provided by the content provider without any prior request. The media presentation description may include sufficient information to locate one or more segments of the summary media presentation and/or the original media presentation, such as the addresses, e.g., the URLs, of the various segments of the summary media presentation and/or the original medial presentation. Upon its receipt, the apparatus 30 embodied by the client device and, more particularly, the processor 32 may parse the media presentation description that describes the summary media presentation and the original media presentation. See block 40 of FIG. 3. As such, the apparatus of one embodiment may include means, such as the processor or the like, for parsing the media presentation description.

In one embodiment, the information that describes the summary media presentation may be included in one or more adaptation sets and/or one or more representations. As such, the apparatus 30 of one embodiment and, more particularly, the processor 32 may be configured to parse the information that describes the summary media presentation from other portions of the media presentation description. In this regard, the apparatus of one embodiment and, more particularly, the processor may be configured to parse the adaptation sets and/or representations of the media presentation description that include information regarding the summary media presentation from other portions of the media presentation description.

As shown in block 42 of FIG. 3, the apparatus 30 of one embodiment and, more particularly, the processor 32 may be configured to process a portion of the summary media presentation to determine addresses of respective segments of the summary media presentation. Thus, the apparatus of one embodiment includes means, such as the processor or the like, for processing a portion of the summary media presentation to determine addresses of the respective segments of the summary media presentation. In one embodiment in which the information describing the summary media presentation is included in one or more adaptation sets, the summary media presentation may be processed by processing one or more adaptations sets of the summary media presentation to determine addresses of the respective segments of the summary media presentation.

By way of example, the apparatus 30 embodied by a client device 12 and, more particularly, the processor 32 may parse the segment template from the AdaptationSet@SegmentTemplate in the media presentation description in case the highlights element is present in the adaptation set. The processor may then recursively substitute the values of the attribute Highlights@value (or Summary@value) for either $Number$ or $Time$ in the segment template, and may recursively substitute the value of the attribute Representation@id or Representation@bandwidth of all representations of the adaptation set for $RepresentationID$ or $Bandwidth$ in the segment template.

Since the URLs of the segments of the summary media presentation are created for the representations in an identical adaptation set, the segments having an identical segment number or segment start time are aligned in presentation time. The highlight representations that have different temporal and special resolution and/or different encoded media bit rates may have identical segment numbers or segment start times if the highlight representations are specified by an identical highlight/summary element. As such, segments from different highlight representations may be requested as long as the highlight representations are described by an identical highlight/summary element. Conversely, the highlight representations may cover different segment numbers or segment start times which are specified by different highlight/summary elements in an adaptation set.

In one embodiment, the client device 12, such as the processor 32, may identify that multiple versions of highlights are provided by the content provider 10 for the client device to select by parsing @highlightsid (or @summaryid) and/or by parsing Highlights@values (Summary@values) of the multiple highlight/summary elements.

As described below, the apparatus 30 embodied by the client device 12 and, more particularly, the processor 32 may select a certain version of highlights/summary to request. To request a more full/complete highlights/summary, a client device may select a highlights (or summary) element assigned with a larger @highlightsid (or @summaryid) as the larger @highlightsid (@summaryid) is used to indicate more segment numbers or segments start times are enumerated in the Highlights@value compared to the one with a smaller Highlights@value. Additionally or alternatively, the client device may select a highlights (or summary) element assigned with more segment numbers or segment start times enumerated in Highlights@values (or Summary@values) to select a more complete highlights/summary.

As also described below, the apparatus 30 embodied by the client device 12 and, more particularly, the processor 32 and/or the communication interface 36 may synchronously present multiple summary media content components together, such as video, audio, timed text and timed graphics, etc. The multiple summary media content components may reside in multiple summary elements in multiple adaptation sets. The client device may use @highlightsid (or @summaryid) to identify those highlights (or summary) elements in different adaptation sets which describes the different type of highlights/summary media representations, corresponding to an identical segments of the summary media presentation.

As shown in block 42 of FIG. 3 and as described above, the apparatus 30 of one embodiment and, more particularly, the processor 32 may be configured to process a portion of the summary media presentation to determine addresses of respective segments of the summary media presentation. In one embodiment in which the information describing the summary media presentation is included in one or more representations, the summary media presentation may be processed by processing one or more representations of the summary media presentation to determine addresses of the respective segments of the summary media presentation.

In one embodiment, the apparatus 30 embodied by the client device 12 and, more particularly, the processor 32 may derive the segment template from the Representation@SegmentTemplate in the media presentation description in an instance in which the highlights (or summary) element is present in a representation. The apparatus of this embodiment and, more particularly, the processor may then recursively substitute the values of the attribute Highlights@value (or Summary@value) for either $Number$ or $Time$ in the segment template. The apparatus and, more particularly, the processor of this embodiment may also substitute the Representation@id or the value of Representation@bandwidth of the containing representation for $RepresentationID$ or $Bandwidth$ if present in the segment template.

As described below, the apparatus 30 embodied by the client device 12 and, more particularly, the processor 32 and/or the communication interface 36 may request the highlight/summary segments from the different representations as long as the Highlights@highlightsid (or Summary@summaryid) in the different representations is identical. The apparatus embodied by the client device and, more particularly, the processor may identify that multiple versions of highlights/summaries are provided by the content provider 10 for the client device to select by parsing @highlightsid (or @summaryid) and/or by parsing Highlights@values (or Summary@values) of the multiple highlight/summary elements. To request a more full/complete highlights/summary, an apparatus embodied by the client device may select a highlights (or summary) element assigned with a larger @highlightsid (or @summaryid) as the larger @highlightsid (@summaryid) is used to indicate more segment numbers or segments start times are enumerated in the Highlights@value compared to the one with a smaller Highlights@value. Additionally or alternatively, the apparatus embodied by a client device may select a highlights (or summary) element with more segment numbers or segment start times enumerated in Highlights@values (or Summary@values) to select a more complete highlights/summary.

As also described below, the apparatus 30 embodied by the client device 12 and, more particularly, the processor 32 and/or the communications interface 36 may synchronously present multiple highlights/summary media content components together, such as video, audio, timed text and timed graphics, etc. The multiple highlights/summary media content components may reside in multiple highlight/summary elements in representations of multiple adaptation sets. The apparatus embodied by the client device and, more particularly, the processor, may use @highlightsid (or @summaryid) to identify those highlight/summary elements in different adaptation sets which describe the different type of highlights/summary media representations, corresponding to an identical segments of the summary media presentation.

As shown in block 42 of FIG. 3 and as described above, the apparatus 30 of one embodiment and, more particularly, the processor 32 may be configured to process a portion of the summary media presentation to determine addresses of respective segments of the summary media presentation. In one embodiment in which the information describing the summary media presentation is included in one or more periods of the media presentation description, the summary media presentation may be processed by processing one or more periods of the summary media presentation to determine addresses of the respective segments of the summary media presentation.

In one embodiment, the apparatus 30 embodied by the client device 12 and, more particularly, the processor 32 may specify summary media presentations for one or multiple adaptation sets of a period using one or multiple highlights elements. Each highlights element may provide an attribute which provides sufficient information to associate with one or multiple adaptation sets. Upon associating a highlights element with one or multiple adaptation sets, the apparatus 30 of one embodiment and, more particularly, the processor 32 can specify the segments of highlights media presentation in conjunction with the highlights element being present in one or multiple adaptation sets.

The apparatus 30 embodied by the client device 12 of one embodiment and, more particularly, the processor 32, the communication interface 36 or the like may then request one or more segments of the summary media presentation based on the addresses of the respective segments. See block 44 of FIG. 3. Thus, the apparatus may include means, such as the processor, the communication interface or the like, for requesting one or more segments of the summary media presentation based on the addresses of the respective segments. As shown in blocks 46 and 48 of FIG. 3, the apparatus embodied by the client device of one embodiment and, more particularly, the processor, the communication interface or the like, may then receive one or more segments of the summary media presentation that have been requested and may, in turn, cause the one or more segments of the summary media presentation that have been received to be presented. Thus, the apparatus may also include means, such as the processor, the communication interface or the like, for receiving one or more segments of the summary media presentation and means, such as the processor, the communication interface or the like, for cause the segment(s) of the summary media presentation to be presented.

In one embodiment, the apparatus 30 embodied by the client device 12 and, more particularly, the processor 32, the communication interface 36 or the like may request, receive and playback summary segments based on the URLs of the highlight/summary segments on the level of an adaptation set and/or a representation. The apparatus embodied by the client device of this embodiment and, more particularly, the processor and/or the communication interface may select a certain version of the summary media presentation segments representing a certain level of fullness/completeness by selecting a certain @highlightsid (or @summaryid) and/or selecting a certain @value. Additionally or alternatively, the apparatus embodied by the client device of this embodiment and, more particularly, the processor and/or the communication interface may adaptively request segments from different highlight/summary representations, representing different bitrates, special and temporal resolution, which are described by the highlights (or summary) elements having an identical @highlightsid (or @summaryid) in an identical an adaptation set.

The apparatus 30 embodied by the client device 12 of one embodiment and, more particularly, the processor 32, the communication interface 36 or the like may specify the whole presentation time duration of the segments of the summary media presentation by parsing the highlights media presentation duration present in the media presentation description and updating the duration in a certain file with the calculated playback time duration of the summary media presentation. In one embodiment, the duration of a media clip may be specified in a track header box such as in ISO base media file format. The apparatus embodied by the client device of one embodiment and, more particularly, the processor may successively find an element of @value and use it to identify the segment number/start time of the next segment of the summary media presentation to be forwarded to the player to present. It should be noted that the segment start time need not used for presentation purposes. The presentation time of a media sample may be specified by accumulatively adding the media sample duration.

In one example embodiment of specifying the highlights media presentation duration of the summary media presentation, @highlightsMediaPresentationDuration may be present as an attribute of a highlights element and used as a mandatory attribute of the highlights element. The @highlightsMediaPresentationDuration may be present in the first highlights element.

In another embodiment of specifying the highlights media presentation duration of the summary media presentation, @highlightsMediaPresentationDuration may be present in a summary media presentation to specify the whole presentation duration of the summary media presentation. In one example embodiment of the corresponding summary media presentation, @highlightsMediaPresentationDuration may be present as an attribute of a new and/or differently configured media presentation description and used as a condition mandatory attribute as shown in Table 3 below.

TABLE 3
Semantics of MPD element

| Element or Attribute Name | Use | Description |
|---|---|---|
| MPD | | The root element that carries the Media |
| | | Presentation Description for a Media |
| | | Presentation. |
| @highlightsMediaPresentation | CM | specifies the duration of the entire |
| Duration | (must | highlights media presentation if |
| | present in | @type = “static”. Otherwise if |
| | case at | @type = “dynamic”, then specifies the |
| | least one | duration of the available highlights media |
| | highlights | presentation. |
| | element is | |
| | present in | |
| | MPD) | |

The media presentation description may consist of multiple periods. Each period may have @start and @duration to specify the presentation time of each period of the original media presentation. Correspondingly, the summary media presentation may consist of one or multiple “highlights periods”. For each highlights periods, the @highlights start is used to specify the start time of the highlights periods. In this regard and as shown in block 44 of FIG. 3 and as described above, the apparatus 30 of one embodiment and, more particularly, the processor 32 may be configured to process a portion of the summary media presentation to determine start time of a portion of summary media presentation in terms of a time period. In one embodiment in which the information describing the summary media presentation is included in elements of multiple periods, e.g., representations and/or adaptation sets of multiple periods, the summary media presentation may be processed by processing elements of one or multiple periods to determine the start time of the respective summary media presentation. If @highlightsstart if present in highlights element, then the highlights start time of a period of a highlights presentation is specified as @highlightsstart. Otherwise, if @highlightsstart is absent in a highlight element, then the communication interface 36 or the like may set the start time of the highlights presentation as the sum of start time and @highlightsduration of the previous period of highlights media presentation. The method, apparatus and computer program product of an example embodiment permits a client device 12 to request and view a summary media presentation with segments of the summary media presentation being identified by information included within the media presentation description. The information included within the media presentation description that describes the summary media presentation may also be used for advertisement insertion by an advertisement insertion agent. In this regard, the advertisement insertion agent may be inserted based on the original media presentation without advertisements. The advertisement insertion agent may be inserted by media delivery networks such as network operators. Since a user of a client device 12 may not wish to view an advertisement when the user views highlights of a media clip, hence the advertisement insertion agent may avoid inserting advertisement near the segments corresponding to the highlights of the media clip. Alternatively, the advertisement insertion agent may intentionally add advertisements prior to playing back the segments corresponding to the highlights in order to obtain a high advertisement presentation rate.

In one embodiment, a method, apparatus and computer program product may permit a client device 12 to switch between the summary media presentation and the original media presentation, such as by switching between corresponding portions of the summary media presentation and the original media presentation. For example, the method, apparatus and computer program product of one embodiment may permit switching between segments of the summary media presentation and the original media presentation that represents the same event, the same scene or the like.

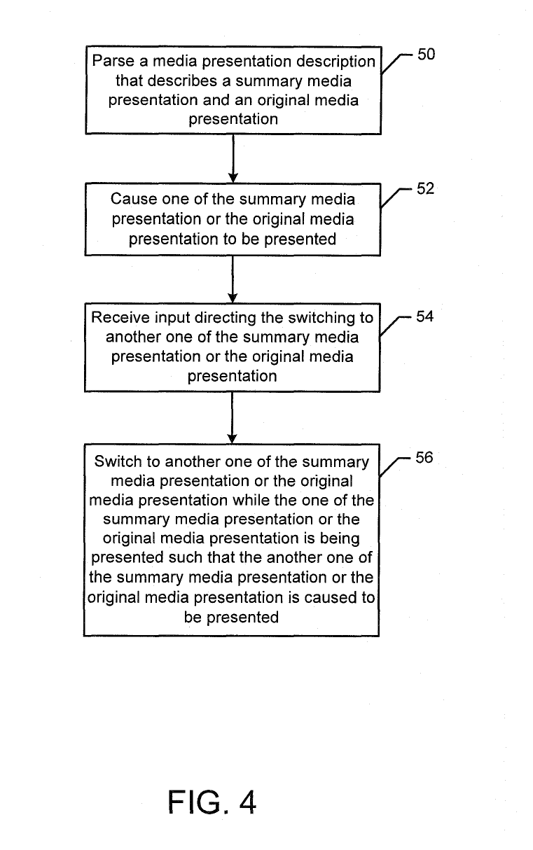

As described above in conjunction with the operations in FIG. 3, a client device 12 may receive a media presentation description that describes a summary media presentation and an original media presentation and may then parse the media presentation description, such as by parsing one or multiple periods, one or more adaptation sets or one or more representations of the summary media presentation that include information regarding segments of the summary media presentation. Thus, the apparatus 30 embodied by the client device may include means, such as the processor 32 or the like for parsing the media presentation description as described above in conjunction with block 40 of FIG. 3. See block 50 of FIG. 4. As thus described in conjunction with blocks 44, 46 and 48 of FIG. 3, the apparatus embodied by a client device and, more particularly, a processor, communication interface 36 or the like may request one or more segments of the summary media presentation or the original media presentation, may receive the one or more segments of the summary media presentation or the original media presentation that were requested and may cause the one or more segments of the summary media presentation or the original media presentation that were requested and received to be presented. Thus, the apparatus embodied by the client device may include means, such as the processor, the communication interface 36 or the like, for causing one or more segments of the summary media presentation or the original media presentation to be presented. See block 52 of FIG. 4.

While one of the summary media presentation or the original media presentation is being presented, the apparatus 30 embodied by the client device 12 of one embodiment and, more particularly, the processor 32 may switch to the other one of the summary media presentation or the original media presentation such that the other one of the summary media presentation or the original media presentation is caused to be presented. See block 56 of FIG. 4. Thus, the apparatus embodied by the client device may include means, such as the processor, the communication interface 36 or the like, for switching to the other one of the summary media presentation or the original media presentation. In this regard, the apparatus embodied by the client device of one embodiment and, more particularly, the processor, user interface 38 or the like, may receive input directing the switching from the one of the summary media presentation or the original media presentation that is being presented to the other one of the summary media presentation or the original media presentation. See block 54 of FIG. 4. The apparatus embodied by the client device of one embodiment may therefore include means, such as the processor, the user interface or the like, for receiving input directing the switch. Following the switch, the other one of the summary media presentation or the original media presentation may be presented.

A method, apparatus and computer program product of an example embodiment permit switching from the presentation of the original media presentation to the summary media presentation or from the presentation of the summary media presentation to the original media presentation. In one embodiment, however, the segment of the other one of the summary media presentation or the original media presentation that is presented following the switch corresponds to the segment of the one of the original media presentation or the summary media presentation that was being presented prior to the switch. For example, the correspondence between the segments of the summary media presentation and the original media presentation that are presented immediately prior and immediately following the switch is based upon the segments of the summary media presentation and the original media presentation representing the same event, the same scene or the like. In this regard, the summary media presentation and the original media presentation may include identical segments that have an identical segment number or an identical segment start time with the identical segments representing the same event, the same scene or the like. Thus, the segments of the summary media presentation and the original media presentation that are presented immediately prior to and immediately following the switch may be identical segments in one embodiment.

By permitting the switching between the summary media presentation and the original media presentation and, more particularly, between corresponding portions of the summary media presentation and the original media presentation, the method, apparatus and computer program product of an example embodiment may facilitate the review by a client device 12 of the media presentation, such as by permitting a client device to efficiently and intuitively switch between corresponding segments of the summary media presentation and the original media presentation depending upon the level of detail that is desired by the client device.

In one embodiment in which the apparatus 30 embodied by a client device 12 switches from the summary media presentation to the original media presentation, the apparatus and, more particularly, the processor 32 may switch during presentation a segment of the summary media presentation after viewing the whole summary media presentation. As the summary media presentation and the original media presentation share an identical segment number or the segment start time for an identical segment, the apparatus embodied by the client device can present the original media presentation by seeking to the parts of the original media presentation that are covered in the summary media presentation. For example, if the user watches a highlight covering the goals of a soccer game, but wishes to see the action of the game that happened before a particular goal, the user may switch from the summary media presentation to the original media so as to see the whole story about the goal. Furthermore, the user interface 38 may be driven by the processor 32 of one embodiment to offer a selection of segments the original media presentation that correspond to parts of the summary media presentation, which enables the user to easily identify and seek to parts of the presentation that are included in the summary media presentation.

In an instance in which a switch is made from the original media presentation to the summary media presentation, the apparatus 30 embodied by the client device 12 may switch during the presentation of the original media presentation. Following the switch, the apparatus embodied by the client device may present the summary media presentation from the beginning or seek to the presentation time which continues the presentation of the original media presentation by using the segment number and segment start times of the summary media presentation and the original media presentation. As noted above, the summary media presentation and the original media presentation may share an identical segment number or the segment start time for an identical segment.

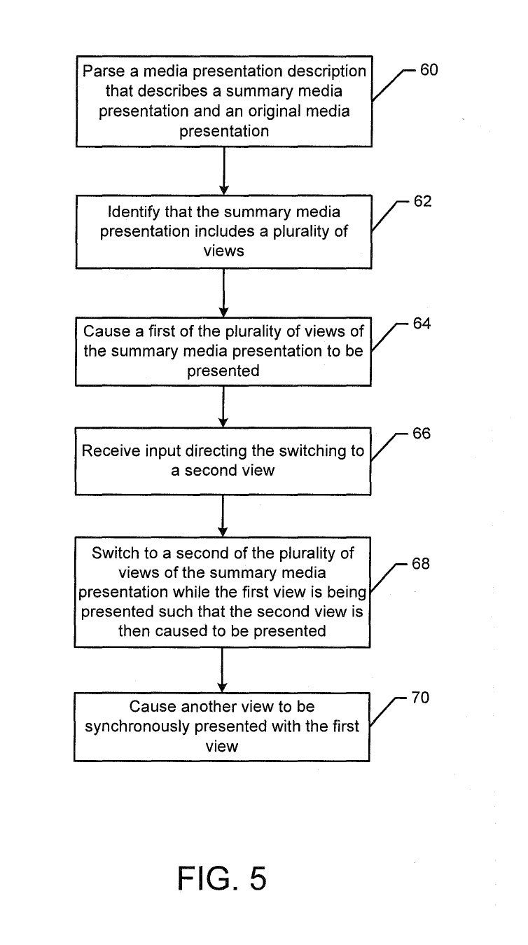

The summary media presentation of one embodiment includes a plurality of views, such as a first view, a second view, etc. The summary media presentation may include different types of views, such as a plurality of views of the same event, of the same scene, etc. In this regard, the plurality of views may be taken from different angles, may be captured with different zooming levels, etc. In one embodiment depicted in FIG. 5, the method, apparatus and computer program product of an example embodiment of the present invention may permit switching between different views of the summary media presentation. In this regard, the apparatus 30 embodied by the client device 12 may receive a media presentation description that describes the summary media presentation and the original media presentation and may parse the media presentation description as shown in block 60 of FIG. 5 and as described above in conjunction with block 40 of FIG. 3. Thus, the apparatus embodied by the client device may include means, such as the processor 32, for parsing the media presentation description. In this embodiment, the apparatus embodied by the client device and, more particularly, the processor may be configured to identify that the summary media presentation includes a plurality of views. See block 62 of FIG. 5. Thus, the apparatus embodied by the client device may include means, such as the processor or the like, for identifying that the summary media presentation includes a plurality of views.

The apparatus 30 embodied by the client device 12 and, more particularly, the processor 32, communication interface 36 or the like, may also cause at least a first of the plurality of views of the summary media presentation to be presented as shown in block 64 of FIG. 5. Thus, the apparatus embodied by the client device may include means, such as the processor, the communication interface or the like, for causing at least a first view to be presented. The apparatus embodied by the client device of this embodiment and, more particularly, the processor, communication interface or the like, may switch to a second of the plurality of views of the summary media presentation while the first view is being presented such that the second view is then caused to be presented. See block 68 of FIG. 5. Thus, the apparatus embodied by the client device may include means, such as the processor, the communication interface or the like, for switching to the second view. In one embodiment, the apparatus embodied by the client device and, more particularly, the processor, the user interface 38 or the like, may receive input directing the switching to the second view. See block 66 of FIG. 5. The apparatus embodied by the client device may therefore include means, such as the processor, the user interface or the like, for receiving input directing the switch of views. Thereafter, the apparatus embodied by the client device and, more particularly, the processor, the communication interface or the like, may cause the second view to be presented. Thus, a client device may readily switch between views, such as by switching between different views of the same event, the same scene or the like.

In one embodiment, the apparatus 30 embodied by the client device 12 and, more particularly, the processor 32, communication interface 36 or the like, may be configured to cause another view, such as a third view, to be synchronously presented with the first and/or the second view. See block 70 of FIG. 5. Thus, the apparatus embodied by the client device of this embodiment may include means, such as the processor, the communication interface or the like, for synchronously presenting a plurality of views.

The apparatus 30 embodied by a client device 12 of one embodiment may want to present multiple highlight/summary views in an asynchronous manner, such as by presenting only one view at a certain time instant and then switching to a different view. To present one view at a certain time instant and switch to another view at another time instant, the apparatus embodied by a client device may select multiple highlight/summary elements, which have identical @highlightsid (or @summaryid), in an identical adaptation set or multiple adaptation sets.

Alternatively, the apparatus 30 embodied by a client device 12 may want to present multiple highlights/summary views in a synchronous manner such that multiple views are presented together synchronously. To present multiple views in a synchronous manner, the apparatus embodied by the client device may select multiple Highlights/Summary elements which have identical @highlightsid (or @summaryid) in multiple adaptation sets.

From the perspective of a content provider 10, an apparatus 30 may be provided to provide a media presentation description describing the original media presentation and the summary media presentation. In this regard, an apparatus embodied by the content provider and, more particularly, the processor 32 may create segments for the original media presentation, but may not need to create separate segments for the summary media presentation and may, instead, specify certain ones of the segments of the original media presentation to also serve as the segments of the summary media presentation. In this regard, an apparatus embodied by the content provider and, more particularly, the processor 32 may create a media presentation description for the original media presentation. See block 80 of FIG. 6. Thus, the apparatus embodied by the content provider may include means, such as the processor 32 for creating the media presentation description. As described above, the media presentation description may include information describing segments of the original media presentation including, for example, addresses, e.g. URLs, of the segments of the original media presentation. The apparatus embodied by the content provider of this embodiment and, more particularly, the processor may add information, such as metadata, regarding a summary media presentation to the media presentation description. See block 82 of FIG. 6. Thus, the apparatus embodied by the content provider may include means, such as the processor, for adding information regarding a summary media presentation to the media presentation description.

In this regard, the information regarding the summary media presentation that is added to the media presentation description may include the addresses of respective segments of the summary media presentation. As described above, the information regarding the summary media presentation may be included in the periods, adaptation sets and/or the representations of the media presentation description. As such, the apparatus 30 embodied by the content provider 10 of one embodiment and, more particularly, the processor 32 may be configured to add the information regarding the summary media presentation to one or more periods of the media presentation description. In another embodiment, the apparatus 30 embodied by the content provider 10 of one embodiment and, more particularly, the processor 32 may be configured to add the information regarding the summary media presentation to one or more adaptation sets of the media presentation description. In another embodiment, the apparatus embodied by the content provider and, more particularly, the processor may be configured to add the information regarding the summary media presentation to one or more representations. Regardless of the manner in which the information regarding the summary media presentation is added to the media presentation description, the information regarding the summary media presentation may be added by the apparatus embodied by the content provider and, more particularly, by the processor such that identical segments of the summary media presentation and the original media presentation have an identical segment number or an identical segment start time.

As shown in block 84 of FIG. 6, the apparatus 30 embodied by the content provider 10 and, more particularly, the processor 32, the communication interface 34 or the like may be configured to cause the media presentation to be provided such as to one or more client devices 12. Thus, the apparatus embodied by the content provider may include means, such as the processor, the communication interface or the lie, for causing the media presentation to be provided to one or more client devices.

In one embodiment, an apparatus 30 embodied by a content provider 10 may create an original media presentation and a media presentation description and may add the summary metadata relating to a summary media presentation to the media presentation description such that multiple versions of summary representations are provided to a client device 12 to select, wherein the versions may represent different media bitrates, temporal or special resolution, etc., and/or represent different fullness/completeness in presenting the original content.

The apparatus 30 embodied by the content provider 10 of one embodiment may specify segment numbers or segment start times for the segments of the summary media presentation and may enumerate the specified segment numbers or segment start times in an @value of a highlights (or summary) element in an adaptation set. By using a common @value on the level of an adaptation set, the apparatus embodied by the content provider can provide segments of the summary media presentation that are aligned in time as a result of the segment numbers or segment start times being identical. Hence, the specified segments of the summary media presentation may have identical segment numbers or segment start times so as to be aligned in presentation time, which allows client devices 12 to access the representations to request the segments of the summary media presentation. In one embodiment, the summary elements in an adaptation set do not need to specify the attribute of spatial, temporal and media bitrate related information and segment template as those attributes can be derived from the adaptation set and/or representation.

The apparatus 30 embodied by the content provider 10 of one embodiment may create multiple versions of the summary in terms of fullness/completeness in describing the original media presentation. For that purpose, the apparatus embodied by the content provider may specify multiple sets of segment numbers or segment start times for the segments of the summary media presentation and may enumerate the specified multiple sets of segment numbers or segment start times in @value(s) of multiple highlights (or summary) elements in an adaptation set. For each version of highlights (or summary) elements in an adaptation set, the apparatus embodied by the content provider may specify @highlightsid (or @summaryid) to indicate fullness/completeness of the highlights/summary, wherein larger @highlightsid may be assigned to the highlight/summary elements covering more complete highlights/summary and smaller @highlightsid may be assigned to the highlight/summary elements covering less complete highlights/summary.

The apparatus 30 embodied by the content provider 10 of one embodiment may specify segment numbers or segment start times for the segments of the summary media presentation and may enumerate the specified segment numbers or segment start times in an @value of a highlight (or summary) element in a period. An attribute may be specified for the highlight (or summary) element in a period to associate a highlights element with one or multiple adaptation sets. The highlight (or summary) element with the said attribute describes the highlights for the parts of the original media presentation, e.g., one or multiple adaptation sets. The apparatus embodied by the content provider of one embodiment may create other attributes in conjunction with attribute creation as described in the highlights element creation in one or multiple adaptation sets.

The apparatus 30 embodied by the content provider 10 of one embodiment may specify segment numbers or segment start times for the segments of the summary media presentation and may enumerate the specified segment numbers or segment start times in an @value of a highlight (or summary) element in a representation. By creating the highlight (or summary) element in a representation, the highlight (or summary) element only applies to the representation in which the highlight (or summary) element resides. The apparatus embodied by the content provider may create one or multiple highlight (or summary) elements in one or multiple representations to create multiple versions of highlights/summary in terms of fullness/completeness in describing the original media presentation. The apparatus embodied by the content provider of one embodiment may specify @highlightsid (or @summaryid) to indicate fullness/completeness of the highlights/summary. The segments of the summary media presentation specified by the highlight (or summary) elements having an identical @highlightsid (or @summaryid) may cover identical segments so that seamless switching between different representations can be obtained by requesting the segments of the summary media presentation with identical @highlightsid (or @summaryid).

In another embodiment, the apparatus 30 embodied by the content provider 10 may create an original media presentation and a media presentation description and may add the summary metadata to the media presentation description such that a client device 12 is capable of flexibly switching between the summary media presentation and the original media presentation.

In this regard, the apparatus 30 embodied by the content provider 10 may specify segment numbers or segment start times for the segments of the summary media presentation and may enumerate the specified segment numbers or segment start times in an @value of a highlight (or summary) element in an adaptation set. The content provider of one embodiment does not need to specify the attribute of spatial, temporal and media bitrate related information and the segment template as these attributes can be derived from the adaptation set and/or the representation. By adding highlight (or summary) elements in an adaptation set, the content provider describes the summary media presentation for each representation of the original media presentation in the adaptation set. In this regard, the content provider allows the client device 12 to create the URLs of the segments of the summary media presentation and the URLs of the segments of the original media presentation corresponding to any representation in a certain adaptation set. The segment numbers or segment start times of the segments of the summary media presentation may be parts of the segment numbers or segment start times of the original media presentations and are aligned with those in presentation time. Hence, the content provider of this embodiment enables the client device to flexibly switch between the summary media presentation and the original media presentation.

In this regard, the apparatus 30 embodied by the content provider 10 of one embodiment may specify segment numbers or segment start times for the segments of the summary media presentation and may enumerate the specified segment numbers or segment start times in an @value of a highlight (or summary) element in an period. By adding highlight (or summary) elements in a period, the content provider describes the summary media presentation for one or multiple adaptation sets of the original media presentation in the period. The content provider of one embodiment may include association indication information in a highlights element in a period to associate the highlights element with one or multiple adaptation sets. The content provider of one embodiment does not need to specify the attribute of spatial, temporal and media bitrate related information and the segment template as these attributes can be derived from the adaptation set and/or the representation. In this regard, the content provider allows the client device 12 to create the URLs of the segments of the summary media presentation and the URLs of the segments of the original media presentation corresponding to any adaptation set in a period. The segment numbers or segment start times of the segments of the summary media presentation may be one or more of the segment numbers or segment start times of the original media presentation and, as such, are aligned with those in presentation time. Hence, the content provider of this embodiment enables the client device to flexibly switch between the summary media presentation and the original media presentation.

The apparatus 30 embodied by the content provider 10 of one embodiment may specify segment numbers or segment start times for the segments of the summary media presentation and may enumerate the specified segment numbers or segment start times in an @value of a highlight (or summary) element in a representation. The attribute of spatial, temporal and media bitrate related information and the segment template may be derived from the representation in which the highlight (or summary) element resides. By adding highlight (or summary) elements in a representation, the apparatus embodied by the content provider describes the summary media presentation for the representation of the original media presentation. As such, the apparatus embodied by the content provider of this embodiment allows a client device 12 to create the URLs of the segments of the summary media presentation and the URLs of the segments of the original media presentation corresponding to the representation in a certain adaptation set. The segment numbers or segments start times of the segments of the summary media presentation may be parts of the segment numbers or segment start times of the segments of the original media presentation in the representation in which the summary element resides. The segment numbers or segments start times of the segments of the summary media presentation may be aligned in presentation time with the part of the segment numbers or segments start times of the original media presentation. Hence, the content provider of one embodiment enables a client device to flexibly switch between the summary media presentation and the original media presentation in a certain representation.

In a further embodiment, the apparatus 30 embodied by a content provider 10 may create an original media presentation and a media presentation description and may then add the summary metadata describing the summary media presentation in the same media presentation description. The apparatus embodied by the content provider of this embodiment may create multiple views in the original media presentation, describe multiple views in the media presentation description and add the summary metadata to describe the summary media presentation for each view separately so as to enable a client device 12 to flexibly switch between multiple views of the summary presentation.

The apparatus 30 embodied by the content provider 10 of one embodiment may create multiple views which present an identical event, but which may be recorded with an identical camera from different angles or with different zooming levels, etc. and/or may be recorded with different cameras from different angles or with different zooming levels.

The apparatus 30 of the content provider 10 of this embodiment may add multiple views in the multiple representations in different adaptation sets and/or may add multiple views in the multiple representations in an identical adaptation set. In an instance in which multiple views are included in different adaptation sets, a client device 12 may present multiple representations (including multiple views) together synchronously if the segments of the different views overlap in presentation time or alternatively present multiple representations (including multiple views) sequentially one after another if the segments of different views do not overlap in presentation time. In an instance in which multiple views are included in an identical adaptation set, a client device 12 may present multiple representations (including multiple views) sequentially one after another if the segments of different views do not overlap in presentation time. The segments of the representations in an identical adaptation set may cover an identical presentation time duration and the segments may be aligned in presentation time.

If the multiple views are created to present multiple views sequentially one after another, the segments' boundary of multiple views may be aligned in presentation time so that the client device 12 may present only one of the views at a certain time instant and may switch between different views.

The apparatus 30 embodied by a content provider 10 of one embodiment may create a highlight/summary element for describing each highlight/summary presentation view. For highlight/summary views, the apparatus embodied by the content provider of this embodiment may specify segment numbers or segment start times and may enumerate the specified segment numbers or segment start times in the @value(s) of a highlight (or summary) elements in different adaptation sets and/or in an identical adaptation set. In one embodiment, the inclusion of multiple original presentation views in different adaptation sets or in an identical adaptation set depends upon whether the highlight (or summary) elements are in different adaptation sets or in an identical adaptation set, respectively.

The highlight/summary views may be presented together synchronously and/or multiple views may be presented sequentially one after another. If the multiple views are created to be presented sequentially one after another, then the segments' boundary of multiple views may be aligned in presentation time so that the client device 12 may present the multiple views sequentially one after another.

The segments of the summary media presentation that are specified by the highlight (or summary) elements having an identical @highlightsid (or @summaryid) may indicate an identical highlights/summary of an event. The apparatus 30 of the content provider 10 may assign a certain @highlightsid (or @summaryid) for multiple highlight/summary views of an event, so that the client device 12 is capable of identifying that one or multiple highlight/summary views are associated with a certain highlights/summary which may be presented together synchronously if the segments of the different views overlap in presentation time or alternatively may be presented sequentially one after another.

As described above, a highlight (or summary) element may present any one or more of a period, an adaptation set and a representation or in any combination of a period, an adaptation set and a representation. Additionally, the highlights related metadata may be specified with different attributes having different names as shown, for example, in Table 1 and Table 2. In one embodiment, for example, the @value attribute is mandatory for every scheme, while the other attributes may be specified as an extension. The highlights related metadata may also or alternatively be specified in a highlights element of highlights scheme and descriptor such as shown in Table 1 and Table 2. Alternatively, the highlights related metadata may be specified as new element or new attributes of a media presentation description such as shown in Table 3.

As a result, the foregoing Tables are provided for purposes of example, but not of limitation as the highlights related metadata may be presented in different levels, e.g., period, adaptation set, representation, and/or in the various manners and in various formats. In instances in which the highlights related metadata is presented in different levels, the highlights metadata may be processed and created in different manners, as described above. In accordance with an example embodiment of the present invention, client devices 12 can obtain a rich streaming experience which may at least consist of, but not be limited to identifying one or multiple versions of segments of the summary media presentation representing different level of completeness in presenting the original content, dynamically requesting the segments covering the summary content from one or multiple representations, viewing the summary media presentation in advance to viewing the whole period of the original media presentation and viewing the original media presentation upon the summary media presentation interesting the user of the client device.

As noted above, FIGS. 3-6 are flowcharts illustrating the operations performed by a method, apparatus and computer program product, such as apparatus 30 of FIG. 2, from the perspective of the content provider 10 in regards to FIG. 6 and the client device in regards to FIGS. 3-5 in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 34 of an apparatus employing an embodiment of the present invention and executed by a processor 32 of the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3-6, when executed, convert a computer or processing circuitry into a particular machine configured to perform an example embodiment of the present invention. Accordingly, the operations of FIGS. 3-6 define an algorithm for configuring a computer or processing circuitry, e.g., processor, to perform an example embodiment. In some cases, a general purpose computer may be provided with an instance of the processor which performs the algorithm of FIGS. 3-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-100. (canceled)

101. A method comprising:
parsing a media presentation description that describes a summary media presentation and an original media presentation;
processing a portion of the media presentation description with a processor to determine addresses of respective segments of the summary media presentation; and
requesting one or more segments of the summary media presentation based on the addresses of the respective segments.

102. A method comprising:
parsing, with a processor, a media presentation description that describes a summary media presentation and an original media presentation;
causing one of the summary media presentation or the original media presentation to be presented; and
switching to another one of the summary media presentation or the original media presentation while the one of the summary media presentation or the original media presentation is being presented such that the another one of the summary media presentation or the original media presentation is caused to be presented.

103. A method according to claim 102, wherein identical segments of the summary media presentation and the original media presentation have an identical segment number or an identical segment start time.

104. A method according to claim 102, wherein one or more segments of the summary media presentation are included within the original media presentation.

105. A method according to claim 102, wherein switching to another one of the summary media presentation or the original media presentation comprises switching to a segment of the another one of the summary media presentation or the original media presentation that corresponds to a segment of the one of the summary media presentation or the original media presentation that is being presented.

106. A method according to claim 105, wherein the segment of the one of the summary media presentation or the original media presentation that is being presented comprises a segment of the summary media presentation, and wherein switching to another one of the summary media presentation or the original media presentation comprises switching to a corresponding segment of the original media presentation.

107. A method according to claim 102, further comprising receiving input directing the switching to another one of the summary media presentation or the original media presentation.

108. An apparatus comprising at least one processor and at least one memory including computer program code, the memory and the computer program code configured to, with the at least one processor, cause the apparatus to:
parse a media presentation description that describes a summary media presentation and an original media presentation;
cause one of the summary media presentation or the original media presentation to be presented; and
switch to another one of the summary media presentation or the original media presentation while the one of the summary media presentation or the original media presentation is being presented such that the another one of the summary media presentation or the original media presentation is caused to be presented.

109. An apparatus according to claim 108, wherein identical segments of the summary media presentation and the original media presentation have an identical segment number or an identical segment start time.

110. An apparatus according to claim 108, wherein one or more segments of the summary media presentation are included within the original media presentation.

111. An apparatus according to claim 108, wherein the memory and the computer program code are configured to, with the at least one processor, switch to another one of the summary media presentation or the original media presentation by switching to a segment of the another one of the summary media presentation or the original media presentation that corresponds to a segment of the one of the summary media presentation or the original media presentation that is being presented.

112. An apparatus according to claim 111, wherein the segment of the one of the summary media presentation or the original media presentation that is being presented comprises a segment of the summary media presentation, and wherein the memory and the computer program code are configured to, with the at least one processor, switch to another one of the summary media presentation or the original media presentation by switching to a corresponding segment of the original media presentation.

113. An apparatus according to claim 108, wherein the memory and the computer program code are further configured to, with the at least one processor, receive input directing the switching to another one of the summary media presentation or the original media presentation.

114. A computer program product comprising a non-transitory computer readable medium having computer-executable program instructions stored thereon, the computer-executable program instructions comprising program instructions configured to:
parse a media presentation description that describes a summary media presentation and an original media presentation;
cause one of the summary media presentation or the original media presentation to be presented; and
switch to another one of the summary media presentation or the original media presentation while the one of the summary media presentation or the original media presentation is being presented such that the another one of the summary media presentation or the original media presentation is caused to be presented.

115. A computer program product according to claim 114, wherein identical segments of the summary media presentation and the original media presentation have an identical segment number or an identical segment start time.

116. A computer program product according to claim 114, wherein one or more segments of the summary media presentation are included within the original media presentation.

117. A computer program product according to claim 114, wherein the program instructions configured to switch to another one of the summary media presentation or the original media presentation comprise program instructions configured to switch to a segment of the another one of the summary media presentation or the original media presentation that corresponds to a segment of the one of the summary media presentation or the original media presentation that is being presented.

118. A computer program product according to claim 117, wherein the segment of the one of the summary media presentation or the original media presentation that is being presented comprises a segment of the summary media presentation, and wherein the program instructions configured to switch to another one of the summary media presentation or the original media presentation comprise program instructions configured to switch to a corresponding segment of the original media presentation.

119. A computer program product according to claim 114, wherein the computer-executable program instructions further comprise program instructions configured to receive input directing the switching to another one of the summary media presentation or the original media presentation.

120. A method comprising:
parsing, with a processor, a media presentation description that describes a summary media presentation and an original media presentation;
identifying that the summary media presentation includes a plurality of views;
causing a first of the plurality of views of the summary media presentation to be presented; and
switching to a second of the plurality of views of the summary media presentation while the first view is being presented such that the second view is then caused to be presented.

121. A method comprising:
creating a media presentation description for an original media presentation;
adding, with a processor, information regarding a summary media presentation to the media presentation description, wherein the information comprises addresses of respective segments of the summary media presentation; and
causing the media presentation description to be provided.
